(19) United States
(12) Patent Application Publication
(10) Pub. No.: US 2025/0332708 A1
(43) Pub. Date: Oct. 30, 2025

(54) Adjustable Tool Storage Device

(71) Applicant: Shawn Ewing, Palmyra, PA (US)

(72) Inventor: Shawn Ewing, Palmyra, PA (US)

(21) Appl. No.: 19/186,077

(22) Filed: Apr. 22, 2025

Related U.S. Application Data
(60) Provisional application No. 63/637,973, filed on Apr. 24, 2024.

(51) Int. Cl. B25H 3/04

(52) U.S. Cl. CPC B25H 3/04

(57) ABSTRACT

An adjustable tool storage device is provided. The device is comprised of a tool storage device formed by at least one horizontal member that attaches to at least one vertical member. The horizontal member can be repositioned along a channel of the vertical member as desired. Then, at least one tool support member can be attached to the horizontal member and can be repositioned along a channel of the member. Then, a tool can be suspended from at least one of the tool support members. In different embodiments, the device may be wall-mounted or free-standing.

### CROSS-REFERENCE TO RELATED APPLICATION

The present application claims priority to, and the benefit of, U.S. Provisional Application No. 63/637,973, which was filed on Apr. 24, 2024, and is incorporated herein by reference in its entirety.

### FIELD OF THE INVENTION

The present invention relates generally to the field of tool storage devices. More specifically, the present invention relates to an adjustable tool storage device with a plurality of repositionable members that can be adjusted to receive tools in a hanging fashion. Accordingly, the present disclosure makes specific reference thereto. Nonetheless, it is to be appreciated that aspects of the present invention are also equally applicable to other like applications, devices, and methods of manufacture.

### BACKGROUND

Individuals who own a variety of tools often choose to store said tools in a centralized location such as a dedicated shelf in the garage or on a spacious workbench. M any tools, especially power tools, may be large and bulky and thus occupy substantial space within a designated storage area. The physical footprint of these tools necessitates thoughtful organization to maximize space efficiency. Furthermore, the risk of tools accidentally falling off a workbench or shelf is a concern, as such incidents can lead to damage, potentially necessitating costly replacements. Further, dealing with disorganization in such a workspace can be a challenging and frustrating experience, especially when it impedes the efficiency and ease of accessing these tools.

Therefore, there exists a long-felt need in the art for a tool storage device. There also exists a long-felt need in the art for an adjustable tool storage device. More specifically, there exists a long-felt need in the art for an adjustable tool storage device that provides a storage device for tools. Further, there exists a long-felt need in the art for an adjustable tool storage device that provides a storage device for tools wherein the position of tools and the configuration of the device are adjustable and customizable.

The subject matter disclosed and claimed herein, in one embodiment thereof, comprises an adjustable tool storage device. The device is comprised of a tool storage device formed by at least one horizontal member that attaches to at least one vertical member. The horizontal member can be repositioned along a channel of the vertical member as desired. Then, at least one tool support member can be attached to the horizontal member and can be repositioned along a channel of the member. Then, a tool can be suspended from at least one of the tool support members. In different embodiments, the device may be wall-mounted or free-standing.

In this manner, the adjustable tool storage device of the present invention accomplishes all the forgoing objectives and provides an adjustable tool storage device that provides a storage device for tools. More specifically, the device allows for the position of tools and the configuration of the device to be adjustable and customizable.12q

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an adjustable tool storage device. The device is comprised of at least one vertical member and at least one horizontal member that attaches to the vertical member. The horizontal member receives at least one repositionable tool support member that can be used to support/store a tool from the horizontal member. In one embodiment, the device may be wall-mounted. In a different embodiment, the device is free-standing. In this embodiment, the vertical member attaches (in a removable or fixedly attached manner) to at least one base.

The vertical member is comprised of at least one channel that receives at least one horizontal member. In one embodiment, the horizontal member is comprised of at least one male fastener that is fixedly attached to the member and can be inserted into the channel of the vertical member to secure the horizontal member at a desired height in the vertical member. In another embodiment, the vertical member is comprised of at least one threaded opening that receives the fastener of the horizontal member (wherein the fastener is also preferably threaded) and secures the position of the horizontal member within the vertical member. In this manner, the user can position the horizontal member at any height along the vertical member to accommodate any size of tool.

The horizontal member may also be comprised of at least one channel that receives at least one tool support member. More specifically, a first end of the tool support member may be comprised of at least one male fastener that is inserted into the channel of the horizontal member and secures the tool support member at a desired location on the horizontal member. The fastener may be fixedly attached to the tool support member or may be placed through the member. In another embodiment, the channel of the horizontal member is comprised of at least one threaded opening that receives the fastener of the tool support member (wherein the fastener is threaded). In this manner, the user can position the support member at any location along the horizontal member to accommodate any size of tool. In one embodiment, the tool support member is comprised of at least one fastener. The fastener may be in the form of a strap or other structure that secures a tool to/within a member.

The present invention is also comprised of a method of using the device. First, a device is provided comprised of at least one vertical member, at least one horizontal member, and at least one tool support member. Then, the horizontal member can be inserted into a channel of the vertical member and can be secured at a height on vertical member via a fastener. Then, at least one tool support member can be inserted into a channel of the horizontal member and secured via at least one fastener of the member. Next, a user can suspend a tool from the support member (or between two support members). Optionally, a user can secure the tool between two support members via attaching at least one fastener to the second end of both members after placing the tool between/in the members.

The present invention is also comprised of a method of using the device. First, a device is provided comprised of at least one vertical member, at least one horizontal member, at least one tool support member, and at least one base. Then, the horizontal member can be inserted into a channel of the vertical member and can be secured at a height along vertical member via a fastener. Then, at least one tool support member can be inserted into a channel of the horizontal member and secured via at least one fastener of the member. Then, the device can be placed on a surface, wherein the base rests on the surface. Then, a user can suspend a tool from the support member (or between two support members).

Accordingly, the adjustable tool storage device of the present invention is particularly advantageous as it provides an adjustable tool storage device that provides a storage device for tools. More specifically, the device allows for the position of tools and the configuration of the device to be adjustable and customizable. In this manner, the adjustable tool storage device provides a solution to storing tools in a central location in a customizable and adjustable manner.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential free-standing embodiment of an adjustable tool storage device of the present invention while storing tools in accordance with the disclosed architecture;

FIG. 2 illustrates a front view of a vertical member of one potential embodiment of an adjustable tool storage device of the present invention in accordance with the disclosed architecture;

FIG. 3 illustrates a front view of one potential wall-mounted embodiment of an adjustable tool storage device of the present invention in accordance with the disclosed architecture;

FIG. 4 illustrates a side cross-sectional view of a tool support member attached to a horizontal member of one potential embodiment of an adjustable tool storage device of the present invention in accordance with the disclosed architecture;

FIG. 5 illustrates a side cross-sectional view of a tool support member attached to a horizontal member of one potential embodiment of an adjustable tool storage device of the present invention in accordance with the disclosed architecture;

FIG. 6 illustrates a perspective view of one potential free-standing embodiment of an adjustable tool storage device of the present invention while storing tools in accordance with the disclosed architecture;

FIG. 7 illustrates a flowchart of a method of using one potential embodiment of an adjustable tool storage device of the present invention in accordance with the disclosed architecture; and

FIG. 8 illustrates a flowchart of a method of using one potential embodiment of an adjustable tool storage device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a tool storage device. There also exists a long-felt need in the art for an adjustable tool storage device. More specifically, there exists a long-felt need in the art for an adjustable tool storage device that provides a storage device for tools. Further, there exists a long-felt need in the art for an adjustable tool storage device that provides a storage device for tools wherein the position of tools and the configuration of the device are adjustable and customizable.

The present invention, in one exemplary embodiment, is comprised of an adjustable tool storage device comprised of at least one vertical member and at least one horizontal member that attaches to the vertical member. The horizontal member receives at least one repositionable tool support member that can be used to support/store a tool from the horizontal member. The device may be wall-mounted or free-standing in different embodiments. In a free-standing embodiment, the vertical member attaches (in a removable or fixedly attached manner) to at least one base.

The vertical member is comprised of at least one channel that receives at least one horizontal member. In one embodiment, the horizontal member is comprised of at least one male fastener that is fixedly attached to the member and can be inserted into the channel of the vertical member to secure the horizontal member at a desired height in the vertical member. In another embodiment, the vertical member is comprised of at least one threaded opening that receives the fastener of the horizontal member (wherein the fastener is also preferably threaded) and secures the position of the horizontal member within the vertical member. In this manner, the user can position the horizontal member at any height along the vertical member to accommodate any size of tool.

The horizontal member may also be comprised of at least one channel that receives at least one tool support member. More specifically, a first end of the tool support member may be comprised of at least one male fastener that is inserted into the channel of the horizontal member and secures the tool support member at a desired location on the horizontal member. The fastener may be fixedly attached to the tool support member or may be placed through the member. In another embodiment, the channel of the horizontal member is comprised of at least one threaded opening that receives the fastener of the tool support member (wherein the fastener is threaded). In this manner, the user can position the support member at any location along the horizontal member to accommodate any size of tool. In one embodiment, the tool support member is comprised of at least one fastener. The fastener may be in the form of a strap or other structure that secures a tool to/within a member.

The present invention is also comprised of a method of using the device. First, a device is provided comprised of at least one vertical member, at least one horizontal member, and at least one tool support member. Then, the horizontal member can be inserted into a channel of the vertical member and can be secured at a height on vertical member via a fastener. Then, at least one tool support member can be inserted into a channel of the horizontal member and secured via at least one fastener of the member. Next, a user can suspend a tool from the support member (or between two support members). Optionally, a user can secure the tool between two support members via attaching at least one fastener to the second end of both members after placing the tool between/in the members.

The present invention is also comprised of a method of using the device. First, a device is provided comprised of at least one vertical member, at least one horizontal member, at least one tool support member, and at least one base. Then, the horizontal member can be inserted into a channel of the vertical member and can be secured at a height along vertical member via a fastener. Then, at least one tool support member can be inserted into a channel of the horizontal member and secured via at least one fastener of the member. Then, the device can be placed on a surface, wherein the base rests on the surface. Then, a user can suspend a tool from the support member (or between two support members).

Accordingly, the adjustable tool storage device of the present invention is particularly advantageous as it provides an adjustable tool storage device that provides a storage device for tools. More specifically, the device allows for the position of tools and the configuration of the device to be adjustable and customizable. In this manner, the adjustable tool storage device provides a solution to storing tools in a central location in a customizable and adjustable manner.

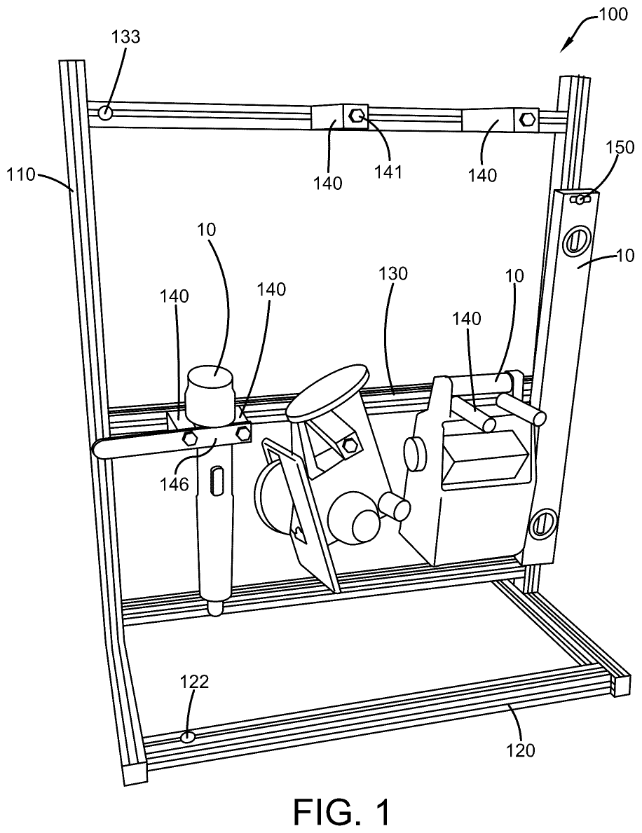

Referring initially to the drawings, FIG. 1 illustrates a perspective view of one potential free-standing embodiment of an adjustable tool storage device 100 of the present invention while storing tools 10 in accordance with the disclosed architecture. The device 100 is comprised of at least one vertical member 110 and at least one horizontal member 130 that attaches to the vertical member 110. The horizontal member 130 receives at least one repositionable tool support member 140 that can be used to support/store a tool 10 from the horizontal member 130. The device 100 and all components are preferably made from a metal, plastic, wood, or other similar durable material of the like.

In one embodiment, the device 100 may be wall-mounted. In this embodiment, the vertical member 110 and/or horizontal member 130 may be comprised of at least one mounting structure 116,136. The structure 116,136 may be in the form of a holed mounting bracket, an opening, or other structure of the like that allows the vertical member 110 and/or horizontal member 130 to be secured to a wall or other surface via a fastener (such as but not limited to a screw, a bolt, etc.).

In a different embodiment, the device 100 is free standing. In this embodiment, the vertical member 110 attaches (in a removable or fixedly attached manner) to at least one base 120. The base 120 is preferably rectangular, but may be any shape. In one embodiment, the base 120 is comprised of at least one mounting structure 122. The structure 122 may be in the form of a holed mounting bracket, an opening, or other structure of the like that allows the base 120 to be secured worktop or other surface via a fastener (such as but not limited to a screw, a bolt, etc.).

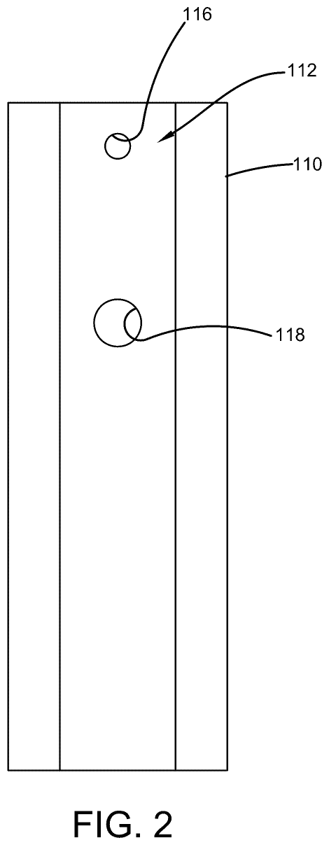

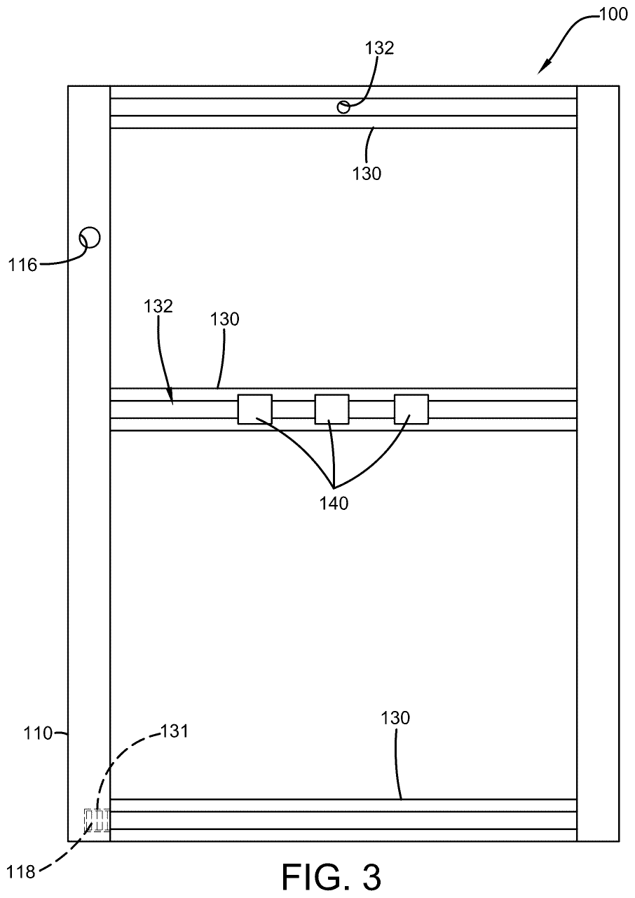

The vertical member 110 is comprised of at least one channel 112, as seen in FIG. 2. The channel 112 preferably runs the length of the vertical member 110. The channel 112 receives at least one horizontal member 130. In one embodiment, the horizontal member 130 is comprised of at least one male fastener 131 that is fixedly attached to the member 130 and can be inserted into the channel 112 of the vertical member 110 to secure the horizontal member 130 at a desired height in the vertical member 110. In another embodiment, the vertical member 110 is comprised of at least one threaded opening 118 that receives the fastener 131 (wherein the fastener 131 is also preferably threaded) and secures the position of the horizontal member 130, as seen in FIG. 3. In this manner, the user can position the horizontal member 130 at any height along the vertical member 110 to accommodate any size of tool 10.

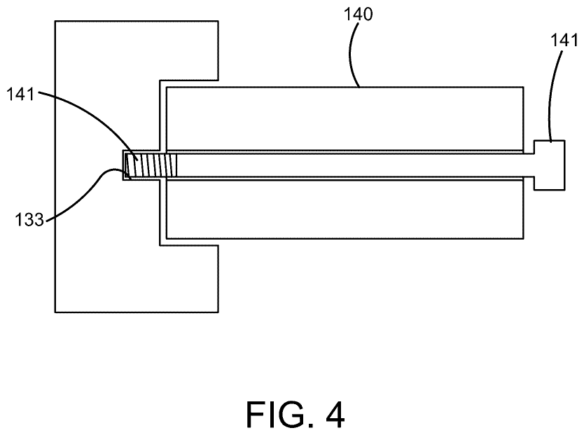

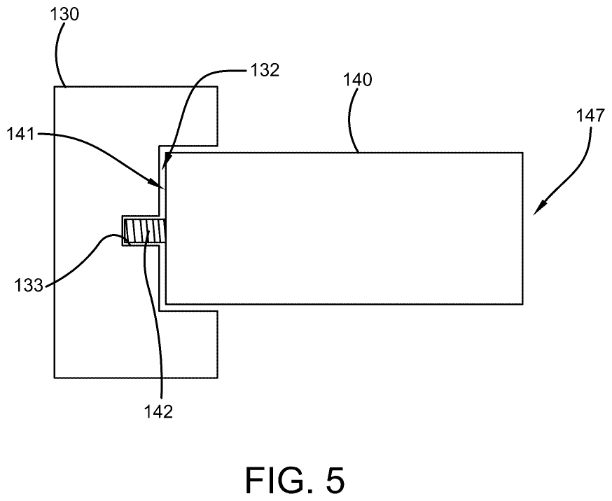

The horizontal member 130 may also be comprised of at least one channel 132. The channel 132 preferably runs the length of the member 130. The channel 132 receives at least one tool support member 140. More specifically, a first end 141 of the member 140 may be comprised of at least one male fastener 142 that is inserted into the channel 132 of the member 130 and secures the tool support member 140 at a desired location on the horizontal member 130. The fastener 142 may be fixedly attached to the member 140 or may be placed through the member 140 (as seen in FIG. 4). In another embodiment, the channel 132 is comprised of at least one threaded opening 133 that receives the fastener 142 (wherein the fastener 142 is threaded) as seen in FIG. 4 and FIG. 5. In this manner, the user can position the support member 140 at any location along the horizontal member 130 to accommodate any size of tool 10. The member 140 may be any shape, size, and configuration in different embodiments.

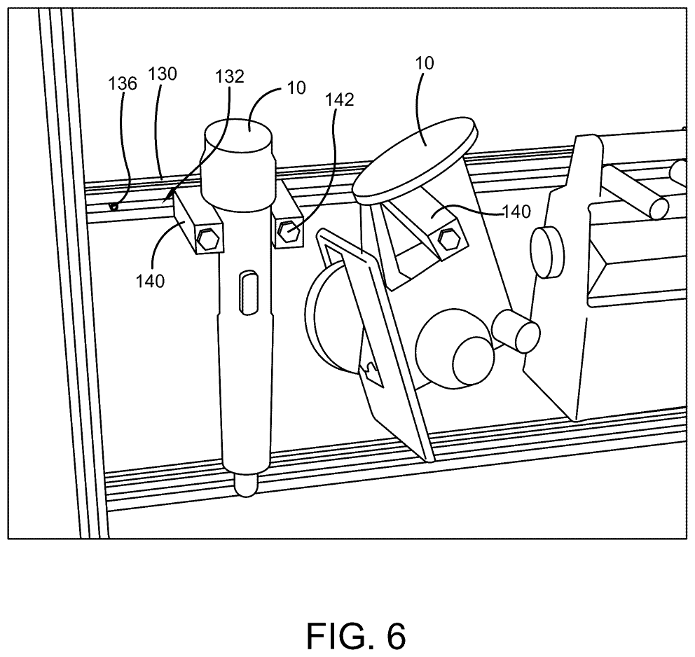

In one embodiment, the member 140 is comprised of at least one fastener 146. The fastener 146 may be in the form of a strap or other structure that secures a tool 10 to/within a member 140, as seen in FIG. 6. By way of example, in one embodiment a tool 10 is positioned between two members 140 and wherein the fastener 146 attaches to both members 146 at the second end 147 of the members 140. In this manner, the tool 10 cannot fall out from between the members 140.

In one embodiment, any portion of the device 100 may be comprised of at least one fastener 150 in the form of a hook or other receiving structure that allows the device 100 to further receive various tools 10.

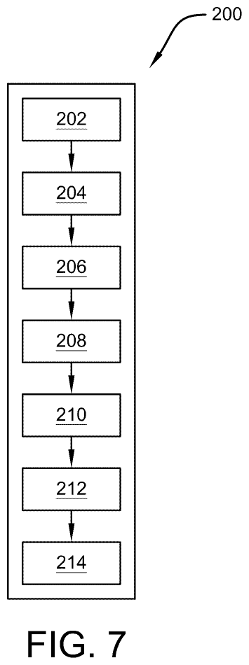

The present invention is also comprised of a method of using 200 the device 100, as seen in FIG. 7. First, a device 100 is provided comprised of at least one vertical member 110, at least one horizontal member 130, and at least one tool support member 140 [Step 202]. Then, the horizontal member 130 can be inserted into a channel 112 of the vertical member 110 and can be secured at a height on vertical member via a fastener 131 [Step 204]. Then, at least one tool support member 140 can be inserted into a channel 132 of the horizontal member 130 and secured via at least one fastener 142 of the member 140 [Step 206]. Next, a user can suspend a tool 10 from the support member 140 (or between two support members 140) [Step 208]. Optionally, a user can secure the tool 10 between two support members 140 via attaching at least one fastener 146 to the second end 147 of both members 140 after placing the tool 10 between/in the members 140 [Step 210]. Further, a user can also hang a tool 10 from at least one fastener 150 [Step 212]. Finally, the vertical member 110 and/or horizontal member 130 can be secured to a surface via placing at least one fastener through at least one mounting structure 116,136 of the members 110,130 and into the surface [Step 214].

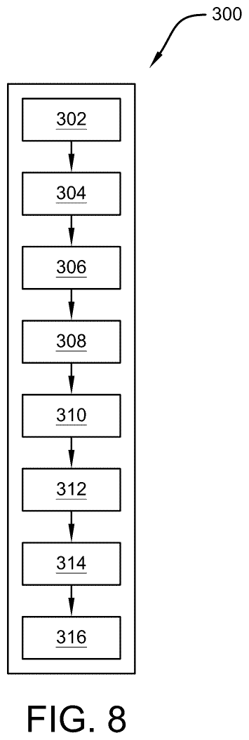

The present invention is also comprised of a method of using 200 the device 100, as seen in FIG. 8. First, a device 100 is provided comprised of at least one vertical member 110, at least one horizontal member 130, at least one tool support member 140, and at least one base 120 [Step 302]. Then, the horizontal member 130 can be inserted into a channel 112 of the vertical member 110 and can be secured at a height along vertical member via a fastener 131 [Step 304]. Then, at least one tool support member 140 can be inserted into a channel 132 of the horizontal member 130 and secured via at least one fastener 142 of the member 140 [Step 306]. Then, the device 100 can be placed on a surface, wherein the base 120 rests on the surface [Step 308]. Optionally, the base 120 can be secured to the surface via placing at least one fastener through at least one mounting structure 122 of the base 120 and into the surface [Step 310]. Then, a user can suspend a tool 10 from the support member 140 (or between two support members 140) [Step 312]. Optionally, a user can secure the tool 10 between two support members 140 via attaching at least one fastener 146 to the second end 147 of both members 140 after placing the tool 10 between/in the members 140 [Step 314]. Further, a user can also hang a tool 10 from at least one fastener 150 [Step 316].

It should be noted that the member 140 may be shaped, sized, and configured to receive any tool type 10 in any storing manner.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “adjustable tool storage device” and “device” are interchangeable and refer to the adjustable tool storage device 100 of the present invention.

Notwithstanding the forgoing, the adjustable tool storage device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the adjustable tool storage device 100 as shown in the FIGS. are for illustrative purposes only, and that many other sizes and shapes of the adjustable tool storage device 100 are well within the scope of the present disclosure. Although the dimensions of the adjustable tool storage device 100 are important design parameters for user convenience, the adjustable tool storage device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An adjustable tool storage device comprising:
a vertical member comprised of a first channel;
a horizontal member comprised of a second channel and a first male fastener; and
a tool support member comprised of a second male fastener.

2. The adjustable tool storage device of claim 1, wherein the vertical member is comprised of a first mounting structure.

3. The adjustable tool storage device of claim 1, wherein the horizontal member is comprised of a second mounting structure.

4. The adjustable tool storage device of claim 1, wherein the first channel is comprised of a first threaded opening.

5. The adjustable tool storage device of claim 1, wherein the second channel is comprised of a second threaded opening.

6. The adjustable tool storage device of claim 1, wherein the second male fastener is comprised of a threaded fastener.

7. An adjustable tool storage device comprising:
a base;
a vertical member comprised of a first channel;
a horizontal member comprised of a second channel and a first male fastener; and
a tool support member comprised of a second male fastener.

8. The adjustable tool storage device of claim 7, wherein the vertical member attaches to the base.

9. The adjustable tool storage device of claim 7, wherein the base is comprised of a first mounting structure.

10. The adjustable tool storage device of claim 7, wherein the vertical member is comprised of a second mounting structure.

11. The adjustable tool storage device of claim 7, wherein the horizontal member is comprised of a third mounting structure.

12. The adjustable tool storage device of claim 7, wherein the first channel is comprised of a first threaded opening.

13. The adjustable tool storage device of claim 12, wherein the horizontal member attaches to the first channel via the first male fastener engaging the first threaded opening.

14. The adjustable tool storage device of claim 7, wherein the second channel is comprised of a second threaded opening.

15. The adjustable tool storage device of claim 14, wherein the tool support member attaches to the second channel via the second male fastener engaging the second threaded opening.

16. A method of using an adjustable tool storage device, the method comprising the following steps:
providing an adjustable tool storage device comprised of a vertical member, a horizontal member, and a tool support member;
attaching the horizontal member to the vertical support member;
attaching the tool support member to the horizontal support member; and
hanging a tool from the tool support member.

17. The method of using an adjustable tool storage device of claim 16, wherein the vertical member is comprised of a first channel.

18. The method of using an adjustable tool storage device of claim 17, wherein the horizontal member is comprised of a second channel.

19. The method of using an adjustable tool storage device of claim 17, wherein the horizontal member is comprised of a first male fastener.

20. The method of using an adjustable tool storage device of claim 17, wherein the tool support member is comprised of a second male fastener.
